(19) United States
(12) Patent Application Publication
(10) Pub. No.: US 2014/0310434 A1
(43) Pub. Date: Oct. 16, 2014

(54) Enlightened Storage Target

(71) Applicant: TRANSPARENT IO, INC., Woodinville, WA (US)

(72) Inventors: John Aaron Strange, Ft. Collins, CO (US); Charles Edward Park, Redmond, WA (US); Robert Pike, Woodinville, WA (US)

(73) Assignee: Transparent IO, Inc., Woodinville, WA (US)

(21) Appl. No.: 13/861,359

(22) Filed: Apr. 11, 2013

(51) Int. Cl. G06F 3/06

(52) U.S. Cl. CPC G06F 3/0653; G06F 3/0604; G06F 3/067
USPC 710/16

(57) ABSTRACT

An enlightened storage target may operate as a conventional storage target device, and may have additional capabilities to manage an initiator-target relationship under a service level agreement or quality of service agreement. An initiator may negotiate a service level agreement with the enlightened target, then the target may manage storage within the target device to meet the service level agreement. The target may also include a monitoring system that may monitor actual performance and compare the performance against the service level agreement. When the service level agreement is not being met, the target may alert the initiator and, in some cases, take precautionary or other actions until the service level agreement is either changed or is met.

### BACKGROUND

Many storage systems may use an initiator and target terminology to describe the connection between various devices. An initiator may be a requestor that uses storage capacity provided by a target. An initiator may be any type of computer, such as a desktop, server, or other computer, which may connect to a storage target through some communication path, such as a network.

The target may provide storage to the initiator, and in many cases, the initiator may access the target as if the target were a locally attached hard disk or other storage device. In some cases, a storage target may be a network attached storage device, storage area network, or some other device. In some cases, a storage target may be a software interface whereby storage on one device may be made available to another device over the network.

### SUMMARY

An enlightened storage target may operate as a conventional storage target device, and may have additional capabilities to manage an initiator-target relationship under a service level agreement or quality of service agreement. An initiator may negotiate a service level agreement with the enlightened target, then the target may manage storage within the target device to meet the service level agreement or multiple service level agreements with multiple initiators. The target may also include a monitoring system that may monitor actual performance or reliability and compare the performance or reliability against the service level agreement. When the service level agreement is not being met, the target may alert the initiator and, in some cases, take precautionary or other actions until the service level agreement is either changed or is met.

### BRIEF DESCRIPTION OF THE DRAWINGS

In the drawings,

FIG. 1 is a diagram illustration of an embodiment showing a storage system that may use an initiator and target.

FIG. 2 is a diagram illustration of an embodiment showing a network environment containing an initiator and target.

FIG. 3 is a flowchart illustration of an embodiment showing a method for negotiating and implementing a service level agreement between an initiator and target.

### DETAILED DESCRIPTION

An enlightened or smart storage target may negotiate and maintain a service level agreement with an initiator. The enlightened target may manage one or more storage devices to present a storage target that maintains a service level agreement, and may notify an initiator when the service level agreement may be violated. The enlightened target may communicate with the initiator over the same connection and protocol for which storage services are delivered.

An enlightened storage target may operate in an initiator-target storage paradigm where a target may provide storage services for an initiator. The initiator may initiate a session, and a target may respond and provide input/output data transfers as well as other block storage operations. In a typical use scenario, a device may act as an initiator to request storage from another device, which may act as a target. The target may configure storage devices and connect to the initiator such that the target acts as a normal storage device to the initiator. In many cases, the initiator may access the target as if the target were a storage device within the initiator's hardware platform or virtualized platform.

The communications network and transport level protocol between an initiator and target may be any type of network or protocol. In practice, iSC SI, Fibre Channel, and other communications standards may be used to connect initiators and target and support higher level storage command and control protocols

The enlightened target may be any device that may be capable of maintaining and monitoring a service level agreement. Such a device may range from a hard disk drive with an embedded controller that may perform the service level agreement management, to a storage area network target that may internally manage multiple storage devices of many different types including a fully software defined storage target, executing in context of physical or virtualized server operating system

The service level agreement may define a performance level that a target may agree to maintain. The performance level may be any performance metric, such as a response time or latency, burst transmission rate, steady state transmission rate, or other metric. In some cases, a service level agreement may have one set of metrics for read operations and another set of metrics for write operations.

The service level agreement may define other metrics for storage. For example, a service level agreement may define that some or all of the data stored on a target may be duplicated on two or more devices. In one such example, a target may be configured with two hard disks, each of which is a mirror of the other.

Some service level agreements may define a data importance, resilience, or other classification metric that may be interpreted and implemented by a target. For example, a service level agreement may request storage for high value data, which may be interpreted to configure a target with mirrored storage to maintain higher degree of resilience. In another example, a service level agreement may request storage for highly sequential data, such as a video data, which may be written and retrieved in a sequential manner.

In some embodiments, data may be tagged with different service level agreements for different types of data, and an enlightened target may be configured to store and retrieve the different types of data in different manners. Using examples above, a target may be capable of identifying tagged high value data and storing the high value data on at least two storage devices, while also identifying a video file and storing the file in a sequential manner. In such embodiments, some data may have one service level agreement applied, while other data may have a second service level agreement applied.

In embodiments with tagged data, the tagging mechanism may be any type of identifier that may be applied to the data. In one implementation, each write command may contain a tag along with the data to be written. Such a system may cause an enlightened target to determine a corresponding service level agreement and apply the service level agreement when storing and retrieving the data.

In another implementation, data may include types and other metadata that may be communicated to the target. For example, a target may receive file type extensions, metadata, or identifiers for which different service level agreements may be defined. Files of one type may have one service level agreement applied, while files of a different type may have a different service level agreement applied.

The enlightened target may perform an ongoing monitoring function that may compare actual performance and configuration against a service level agreement. When the enlightened target may not be able to maintain a service level agreement, the target may take some action. In many embodiments, the target may send an alert or other communication to an initiator, and the initiator may take some corrective action. In some embodiments, the target may attempt some corrective action on its own. The target may, for example, reconfigure its storage devices to better meet a service level agreements for given initiator and given sets of tagged data.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

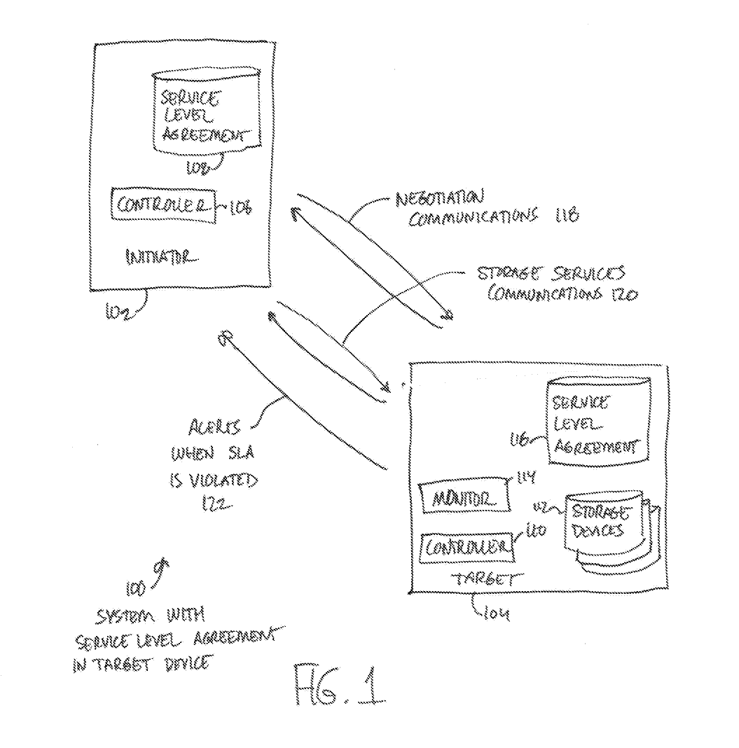

FIG. 1 is a diagram of an embodiment 100 showing an initiator 102 and a target 104 in a storage system. Embodiment 100 is a generalized illustration showing the operations of an enlightened target device that may process a service level agreement as part of a distributed storage system.

The initiator 102 and target 104 may operate as a storage system for the initiator 102. The initiator 102 may request access to storage from the target 104, and the target 104 may deliver storage services to the initiator 102.

An initiator and target storage configuration may be a mechanism by which various storage devices act as targets, while an initiator system uses the storage services. In a typical embodiment, an initiator 102 may be a server computer, desktop computer, or other computing device that may connect to one or more target devices for storage. The target devices may be internally connected to the initiator, such as flash storage or hard disk storage that may be mounted inside a computer chassis.

In some embodiments, the target devices may be connected to an initiator over a network connection. For example, a server computer in a datacenter may establish a storage repository over a Fibre Channel, Ethernet, or other network to one or more target devices. The target devices may be other server computers with excess storage, Storage Area Networks, Network Attached Storage devices, or other storage systems.

The target devices may manage the storage services against a service level agreement. The service level agreement may define the services that the target device agrees to provide, and in many cases, the service level agreement may include performance parameters. The target device may include a monitoring system that may compare actual performance against the service level agreement and may take certain actions when the target device does not comply with the service level agreement.

The target device may have sophisticated management logic that may configure and manage multiple storage devices. Such a target device may be, for example, a Storage Area Network or Network Attached Storage device that may have many available storage devices. Such targets may be able to configure multiple devices to meet a requested service level agreement. Further, such targets may be able to arbitrate conflicting service level agreements for multiple concurrent initiators.

To meet a requested service level agreement, a target device may evaluate several different configurations that may meet a service level agreement. As an example, a target device may configure multiple hard disks in a striped configuration so that the throughput for read and write operations may be higher than the throughput of one device on its own. In another example, a target device may configure flash storage to meet a service level agreement that requests very fast seek times.

In such embodiments, a target device may evaluate a service level agreement to determine a configuration of storage devices that may meet a requested service level agreement. In such embodiments, a service level agreement may originate with an initiator. When a target device may not be able to meet a requested service level agreement, a target may determine a service level agreement that may be met given the existing capabilities and capacities of the target device.

In some such embodiments, a negotiation may ensue between the initiator and target to determine an acceptable service level agreement. In some such cases, an initiator or a target itself may determine that the target may not suit the requested application and no storage services may be provided. In other cases, an initiator may modify its requested service level agreement to meet the service level agreement that the target may be capable of providing.

An initiator 102 may request a service level agreement from a target 104 at the beginning of a negotiation. Such an embodiment may be useful when the target 104 may not have the capability of reconfiguring itself. An example of such an embodiment may be a single storage device, such as a hard disk drive or a solid state memory device, where a controller on the target 104 may not be capable of reconfiguration of storage services.

In such an embodiment, a target may provide a service level agreement to an initiator so that the initiator may determine whether or not the target device may be appropriate for storage services. In one use scenario, an initiator 102 may establish communications with a target 104, then request the target's service level agreement. The target's service level agreement may define the capacities and capabilities of the target device, and the initiator 102 may determine if the target's capabilities meets a service level agreement that the initiator desires.

In some cases, the initiator 102 may determine that another target device with a different capabilities and different service level agreement may be more appropriate. In such a manner, the initiator 102 may evaluate multiple potential targets until one of the potential targets may meet a requested service level agreement.

The enlightened target may monitor storage resources to meet a service level agreement. A target device may monitor the performance of read and write requests, as well as other factors, to determine whether a service level agreement is being met or not. When the service level agreement is not being met, the target may notify the initiator, take corrective action, or some other action as appropriate.

The architecture of having a target device monitor its performance against a service level agreement may place the monitoring and management function on the lowest level device in the system that may perform a monitoring function. Such an architecture may unburden the initiator from monitoring and managing individual target devices and allow the target devices to perform much of that function. The target devices may be closest to the read and write operations and may therefore have a better opportunity to measure the actual performance and take initial corrective action in some cases.

In embodiment 100, an initiator 102 and target 104 are illustrated. The initiator 102 may contain a controller 106 and a service level agreement 108. The target 104 may contain a controller 110 that may manage one or more storage devices 112, as well as a monitor 114. The target's storage level agreement 116 may be computed by the controller 110 or may be provided by the initiator 102 in different use scenarios.

The initial communications between the initiator 102 and target 104 may involve negotiation communications 118. In the negotiation communications 118, the initiator 102 and target 104 may determine a service level agreement that the target 104 may attempt to meet. In some cases, the negotiation may involve the initiator pushing a service level agreement to a target device. In other cases, the negotiation may involve the target device sending a service level agreement, while still other cases may involve a more protracted negotiation process.

Once the service level agreement 116 is in place and the initiator 102 and target 104 are in agreement, storage services communications 120 may commence. The storage services communications 120 may involve read and write requests sent from the initiator 102 and responded to by the target 104.

The target 104 may monitor the performance of itself against the service level agreement 116. When the performance or capabilities of the target 104 may violate the service level agreement 116, the target may send an alert 122. In some cases, the target 104 may take additional corrective action such as reconfiguring itself in an attempt to remain compliant with the service level agreement 116.

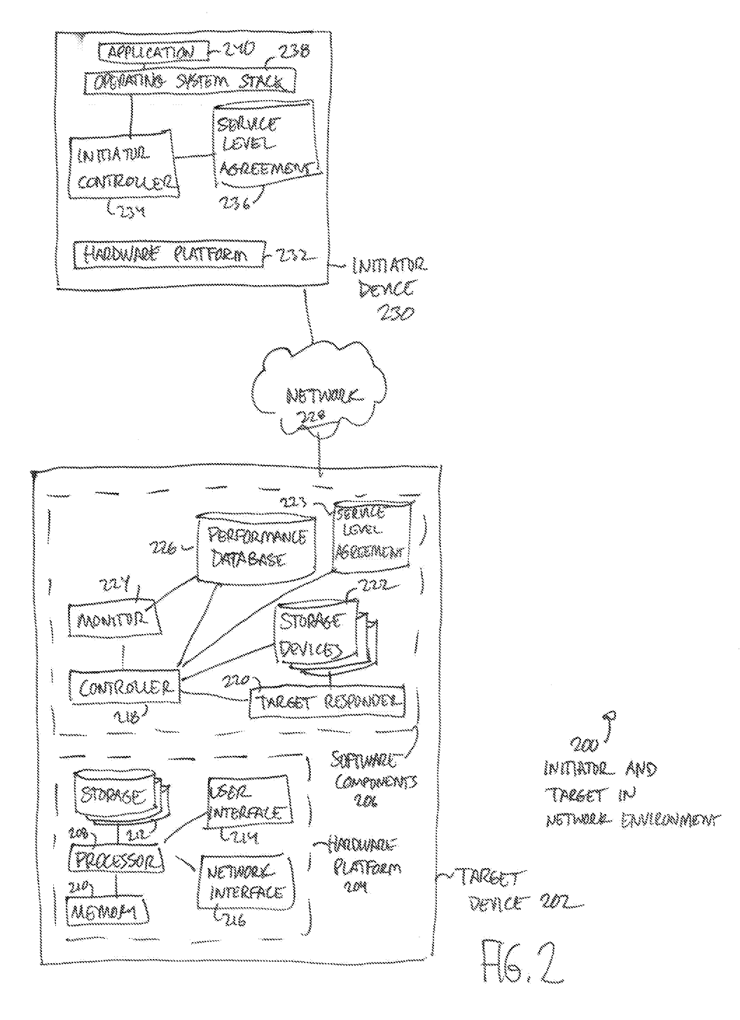

FIG. 2 is a diagram of an embodiment 200 showing a network environment with an initiator device and target device. Embodiment 200 may illustrate one embodiment in which an enlightened target device may operate.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates one embodiment in which an initiator and target device may operate. An initiator device 230 is illustrated as being connected to a target device 202 over a network 228. In some embodiments, the network 228 may be a wired or wireless network that may span several feet or many miles of distance. In a typical version of such an embodiment, the target device 102 may be a Storage Area Network or other device attached to the network 228 that may provide storage services across the network.

In other embodiments, the initiator device 230 and target device 202 may be incorporated into a single cabinet or chassis, and the target device 202 may be a peripheral device that may be connected over a SCSI, IDE, or other network connection. In one such embodiment, the target device 202 may be a single hard disk drive or solid state storage device that may include a controller and monitor that may manage performance against a service level agreement.

Embodiment 200 illustrates a target device 202 that may have a hardware platform 204 and various software components 206. The target device 202 as illustrated represents a conventional computing device, although other embodiments may have different configurations, architectures, or components.

In many embodiments, the target device 202 may be a server computer. In some embodiments, the target device 202 may still also be a desktop computer, laptop computer, netbook computer, tablet or slate computer, wireless handset, cellular telephone, game console or any other type of computing device.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include a controller 218, which may receive and transmit communications across a target responder 220. The target responder 220 may be a software component that may listen for and respond to commands from an initiator 230. The controller 218 may receive commands relating to a service level agreement 223. Such commands may include requests for a service level agreement that the target 202 may transmit to the initiator device 230, as well as a service level agreement sent from the initiator device 230 to the target 202. The commands may also include various monitoring, querying, and other commands that may allow an initiator 230 to configure the target device 202 to manage storage according to a service level agreement 223.

A monitor 224 may determine a status of the target device 202 with respect to the service level agreement 223. The status may determine whether or not the services provided by the target device 202 are in compliance with the service level agreement 223. In some embodiments, the monitor 224 may actively test the storage devices 222 to determine their capabilities. In some embodiments, the monitor 224 may passively or actively monitor incoming requests and outgoing responses to determine compliance. A performance database 226 may be a repository that may contain performance history data and other information collected by or used by the monitor 224 and controller 218 in various situations.

An initiator device 230 may contain a hardware platform 232 that may be similar to the hardware platform 202. In many embodiments, the initiator 230 may be a programmable computing device, such as a desktop computer, laptop computer, server computer, tablet computer, netbook computer, game console, portable device, mobile telephone, or other computing device.

An initiator controller 234 may have a service level agreement 236 that may be defined for a larger storage system. In some embodiments, the service level agreement 236 may be a larger goal that a controller 234 may try to meet by assembling multiple target devices into a large storage system.

The initiator controller 234 may operate underneath or part of an operating system stack 238. Various applications 240 may request storage from the operating system stack 238, which may in turn pass storage requests to the controller 234, which may in turn pass storage requests to the target responder 220 of the target device.

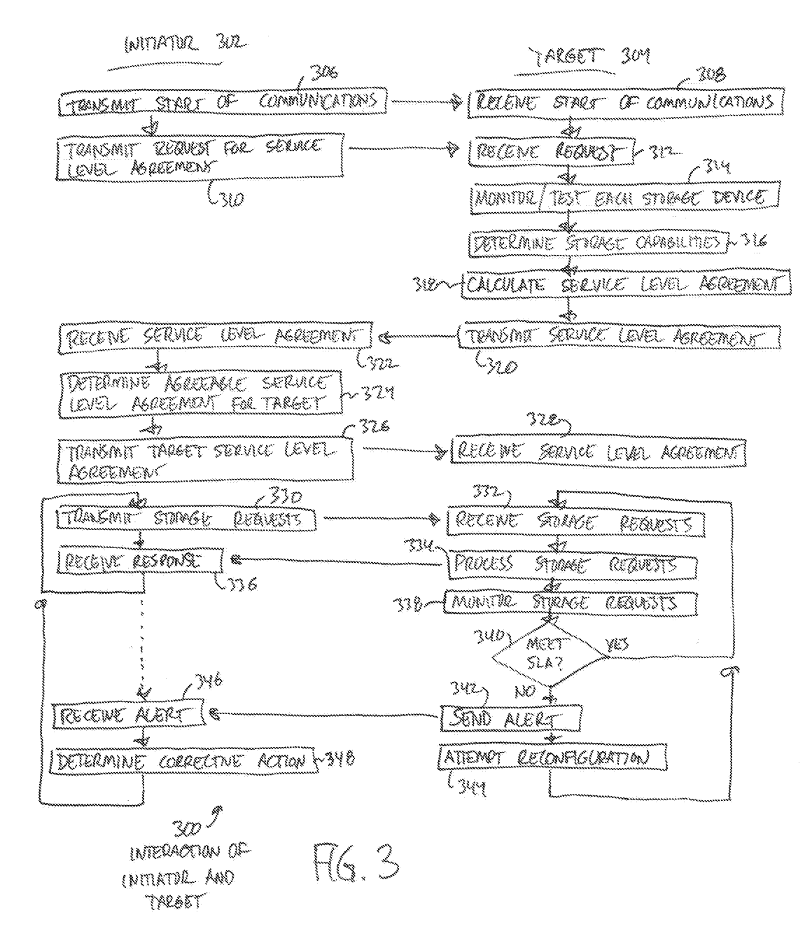

FIG. 3 is a flowchart illustration of an embodiment 300 showing communications between an initiator 302 in the left hand column and a target 304 in the right hand column. The communications may reflect an example of negotiations prior to providing storage services, the storage services themselves, and actions that may be performed when a service level agreement may be violated.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In block 306, an initiator 302 may start communications with the target 304, which may receive the communications in block 308. As part of the negotiation phase, the initiator 302 may request a service level agreement from the target in block 310, which the target may receive in block 312.

The target 304 may monitor or test the available storage devices in block 314 and may determine various storage capabilities in block 316. The target 304 may calculate a service level agreement in block 318, which may be transmitted to the initiator in block 320.

The initiator 302 may receive the target's service level agreement in block 322 and determine an agreeable service level agreement in block 324. The initiator 302 may transmit a service level agreement in block 326, which may be received in block 328 by the target. The target 304 may then begin operations using the service level agreement received in block 328.

The example of blocks 306 through 328 illustrate one method of negotiation between the initiator 302 and target 304. In the illustrated method, an initiator 302 may request a service level agreement from the target 304, where the service level agreement provided by the target may reflect the capabilities that the target 304 may expect to produce. When the target's service level agreement is as good as or better than the initiator's service level agreement, the target may be brought online to service requests. If the target's service level agreement was not acceptable, the initiator may stop further communications and attempt to find a different target device.

In another method for negotiation, an initiator 302 may transmit a proposed service level agreement to the target 304. The target 304 may then evaluate the proposed service level agreement to determine whether or not the target may be able to meet the request. When the target is able to meet the requested service level agreement, the storage services may begin. When the target may not be able to meet the requested service level agreement, the target may respond with a second proposed service level agreement for the initiator to consider. The initiator may agree to use the target's proposed service level agreement or may attempt to use another target device.

In block 330, storage requests may be transmitted to the target 304, which may receive the storage requests in block 332. The storage requests may generally be read and write requests.

The target 304 may process the storage requests in block 334, which may be received by the initiator 302 in block 336. The initiator 302 may cycle through blocks 330 and 336 to send requests and receive responses.

The target 304 may monitor the storage requests in block 338. If the target 304 meets the service level agreement in block 340, the process may return to block 332 to receive the next storage request. When the target 304 does not meet the service level agreement in block 340, an alert may be sent in block 342, which the initiator 302 may receive in block 346.

Based on the alert in block 346, an initiator 302 may determine any corrective action in block 348. In some embodiments, the corrective action may be to search for a different target device, configure the new target device, and migrate any data stored in the target 304 to the new target device. In some embodiments, the corrective action may be to alert a human administrator who may investigate the problem. In some cases, the human may elect to change the service level agreement, fix the target 304, or some other change.

The target 304 may attempt to reconfigure itself in block 344 to meet the service level agreement. The reconfiguration may be possible for devices that may have multiple storage options, while little or no reconfiguration may be possible for some devices that have only one storage option.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on a computer processor, said method comprising:
receiving a first communication from a storage initiator, said first communication comprising a service level agreement;
providing storage services to said storage initiator;
monitoring said storage services and comparing said storage services to said service level agreement;
detecting that said storage services do not comply with said service level agreement; and
transmitting a second communication to said storage initiator, said second communication comprising an alert.

2. The method of claim 1, said first communication and said second communication being transmitted on a first network connection, said storage services being performed on said first network connection.

3. The method of claim 2, said storage services being provided from a plurality of storage devices.

4. The method of claim 3, said plurality of storage devices being non-homogenous.

5. The method of claim 4 further comprising:
reconfiguring said plurality of storage devices in response to detecting that said storage services do not comply with said service level agreement.

6. The method of claim 5 further comprising:
detecting that said service level agreement is met after said reconfiguring, and transmitting a third communication to said storage initiator.

7. The method of claim 6, said reconfiguring comprising configuring a plurality of devices to a striped configuration.

8. The method of claim 7, said service level agreement comprising a data transfer rate.

9. The method of claim 8, said first communication being a Small Computer System Interface (SCSI) communication.

10. The method of claim 1 further comprising:
testing a first storage device and determining that said first storage device can comply with said service level agreement.

11. The method of claim 10 further comprising:
testing a second storage device and determining that said second storage device cannot comply with said service level agreement; and
configuring said first storage device to provide said storage services to said initiator.

12. The method of claim 11 further comprising:
determining that said service level agreement defines that a plurality of storage devices provide said storage services; and
configuring a plurality of storage devices to provide said storage services.

13. A system comprising:
a communications connection to a network;
at least one storage device;
a controller that:
receives a first communication from a storage initiator, said first communication comprising a service level agreement and being received on said communications network;
provides storage services to said storage initiator, said storage services being provided over said communications network;
monitors said storage services and comparing said storage services to said service level agreement;
detects that said storage services do not comply with said service level agreement; and
transmits a second communication to said storage initiator, said second communication comprising an alert.

14. The system of claim 13 further comprising:
a monitor that determines a performance metric for said at least one storage device.

15. The system of claim 14, said performance metric being determined prior to configuring said at least one storage device to provide said storage services.

16. The system of claim 14, said performance metric being determined while providing said storage services.

17. The system of claim 13, said first communication and said storage services being transmitted using a first protocol.

18. The system of claim 17, said first protocol being a Small Computer System Interface (SCSI) protocol.

19. The system of claim 13 comprising a plurality of storage devices.

20. The system of claim 19, said controller that further:
reconfigures said plurality of storage devices based on detecting that said storage services do not comply with said service level agreement.
